(19) United States
(12) Patent Application Publication
(10) Pub. No.: US 2013/0290076 A1
(43) Pub. Date: Oct. 31, 2013

(54) PARKING METER COMPRISING MEANS FOR TRANSMITTING A USER'S PERSONAL MESSAGE, AND URBAN PARKING ZONE COMPRISING SAID PARKING METERS

(71) Applicants: Stephane Bobillier-Chaumont, Besancon (FR); Eric Pretet, Routelle (FR)

(72) Inventors: Stephane Bobillier-Chaumont, Besancon (FR); Eric Pretet, Routelle (FR)

(73) Assignee: PARKEON, Paris (FR)

(21) Appl. No.: 13/823,331

(22) PCT Filed: Dec. 8, 2011
(86) PCT No.: PCT/EP2011/072189

§ 371 Date: Jul. 17, 2013

(30) Foreign Application Priority Data
Dec. 8, 2010 (FR) 1060258

(51) Int. Cl. G07B 15/06

(52) U.S. Cl. CPC G07B 15/06
USPC 705/13

(57) ABSTRACT

This on-street parking meter (12) capable of issuing a payment ticket includes communication elements (24) using a communication protocol with a computer server (25), elements (16) for entering alphanumeric characters, elements (14) for displaying the characters entered by the user (30), elements (36) for generating a parking message and elements (44) for transmitting the message to the computer server. The parking meter (12) further includes elements (38) for creating a user's (30) personal message from the characters entered by the user, elements (40) for discriminating the end destination of the message to be transmitted, the end destination of the user's (30) personal message being another user's (48) electronic device and the end destination of the parking message being a parking data management unit (50), and elements (42) for triggering, at the user's request, the transmission of the personal message to the computer server.

The present invention concerns an on-street parking meter capable of issuing a payment ticket, of the type comprising communication means using a communication protocol to communicate with a computer server, means for entering alphanumeric characters, means for displaying the characters entered by the user, means for generating a parking message and means for transmitting the message to the computer server.

The invention also concerns an urban parking zone comprising a plurality of said on-street parking meters.

The invention also concerns a method for transmitting an electronic message from an on-street parking meter.

A parking meter is known from document FR 2 780 223 A1 comprising means for payment, means for printing out the payment ticket, a central unit and means for communicating with a data server. The communication means comprise a modem and an antenna. The parking meter also comprises a selection interface comprising a graphic screen and a device for selecting data displayed on the screen. The parking meter provides a user with access to various items of information displayed on the screen, and allows the consulting of practical information such as a town map or information on public transport.

However, said parking meter offers a restricted number of operating functions.

It is the objective of the invention to propose a parking meter which offers an additional operating function.

For this purpose, the subject of the invention is a parking meter of the aforementioned type characterized in that further comprises:
means to create a user's personal message using the characters entered by the user;
means for discriminating the end destination of the message to be transmitted, the end destination of the user's personal message being an electronic device of another user, and the end destination of the parking message being a parking data management unit; and
triggering means to trigger, at the user's request, the transmission of the said personal message to the computer server.

According to other embodiments, the parking meter comprises one or more of the following characteristics taken alone or in any possible technical combination:
the parking meter also comprises image and/or sound capture means, the capture means being connected to the creation means;
the parking meter comprises additional short distance communication means and means for downloading data from an external electronic device to the parking meter, the external electronic device being connected to the parking meter via additional communication means;
the creation means are able to create a minimessage of SMS or MMS type, the communication protocol conforming to the SMPP protocol or MMS protocol;
the creation means are capable of creating an e-mail, the communication means being capable of communicating with an internet server;
the parking meter further comprises means for printing a receipt containing the text of the transmitted personal message; and
the parking meter further comprises means for receiving an electronic message in reply to the previously transmitted personal message.

A further subject of the invention is an urban parking zone comprising a plurality of on-street parking meters, characterized in that each parking meter is such as defined above.

A further subject of the invention is a method for transmitting an electronic message from an on-street parking meter capable of issuing a payment ticket, and comprising communication means with a computer server, means for entering alphanumeric characters, means for displaying the entered characters, means for generating a parking message and means for transmitting the message to the computer server,

the method being characterized in that it comprises:
the creation of a personal electronic message from the characters entered by the user via the character entry means;
discrimination of the end destination of the message to be transmitted, the end destination of the user's personal message being another user's electronic device, and the end destination of the parking message being a parking data management unit; and
the transmission, at the user's request, of the said personal electronic message to the computer server.

According to another embodiment the method further comprises, after the transmission of the message, the print-out of a receipt containing the text of the transmitted electronic message.

These characteristics and advantages of the invention will become apparent on reading the following description given solely as an illustration and with reference to the appended drawings in which:

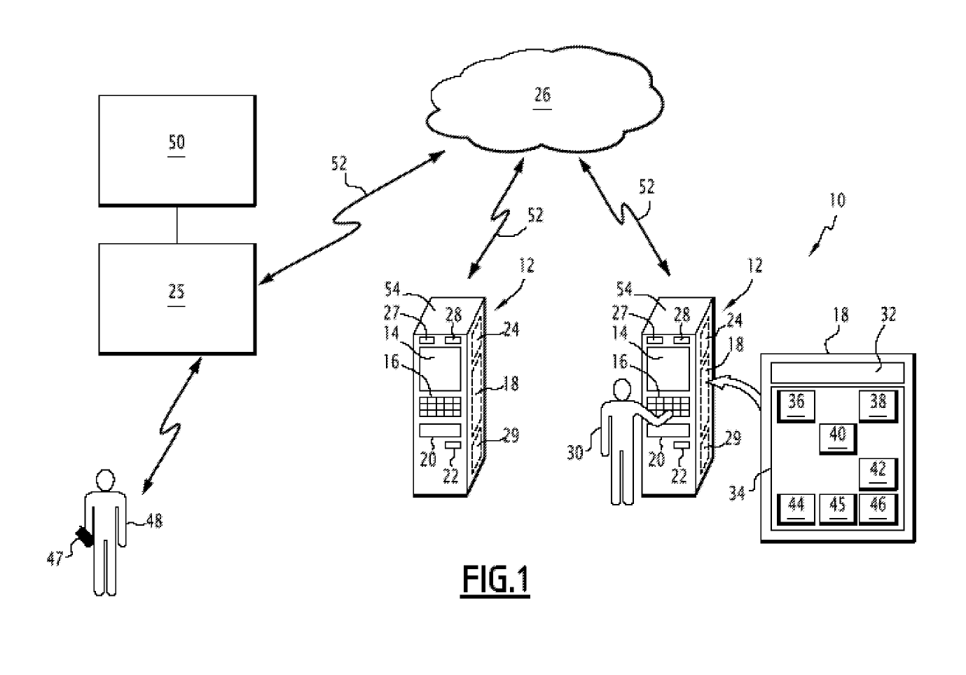

FIG. 1 is a schematic illustration of an urban parking zone comprising a plurality of parking meters according to the invention, each parking meter being connected to a computer server; and

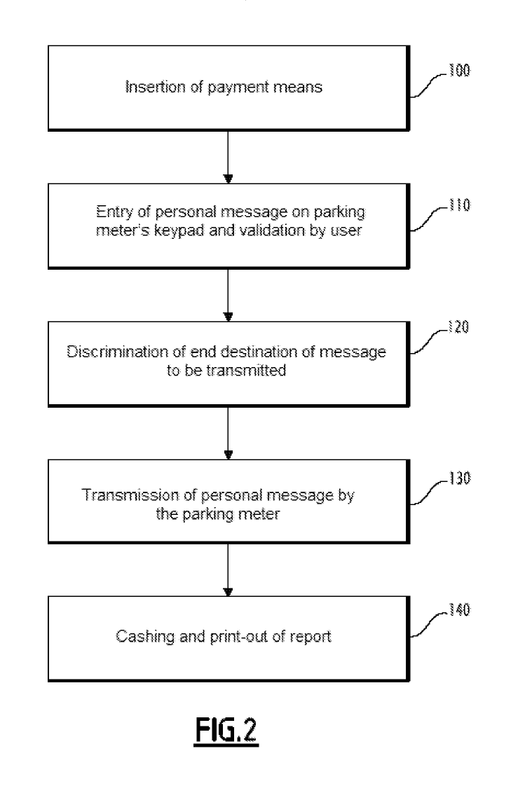

FIG. 2 is a flow chart of a method for transmitting an electronic message from the parking meter in FIG. 1.

In FIG. 1, an urban parking zone 10 comprises a plurality of on-street parking meters 12.

Each parking meter 12 is capable of issuing a payment ticket. Each parking meter 12 comprises a display screen 14, a keypad 16 to enter alphanumeric characters, a data processing unit 18, a payment device 20 and printing means 22.

The parking meter 12 also comprises communication means 24 using a communication protocol to communicate with a computer server 25 via a communication network 26.

Additionally, the parking meter 12 comprises image and/or sound capture means 27 and additional short distance communication means 28.

The parking meter 12 comprises means 29 for supplying electric power to the parking meter.

Each parking meter 12 is installed on a street and is able to be used by a user 30.

The entry keypad 16 is a capacitive keypad for example independent of the display screen 14. As a variant, the entry keypad is a mechanical keypad for example. As a variant, the display screen is a touch screen, and the entry keypad is a touch keypad formed of keys displayed on the screen.

The data processing unit 18 comprises a data processor 32 for example associated with a memory 34. The memory 34 is able to store software 36 to generate a parking message, software 38 to create a user's personal message from the characters entered by the user, discriminating software 40 to discriminate the end destination of the message to be transmitted.

The memory 34 is also able to store software 42 for triggering transmission of the personal message, at the user's request, to the computer server, software 44 to transmit the personal or parking message, and software 45 to receive an electronic message via the communication means 24 in reply to a previously transmitted personal message.

In addition, the memory 34 is able to store software 46 to download data from the parking meter to an external electronic device, not illustrated, or else from the external electronic device to the parking meter, the external electronic device being connected to the parking meter via additional communication means 28.

The end destination of the message transmitted to the server is an electronic device 47 of another user 48 if the message is a personal message created by the user, and the end destination of the message transmitted to the server is a parking data management unit 50 if the message is a parking message.

For example the payment device 20 comprises a chip card reader, a contactless card reader and a change machine, not illustrated.

The printing means 22 are able to print the payment ticket and/or a receipt containing the text of the transmitted personal message.

The communication means 24 comprise a wireless transmitter-receiver conforming to the communication standard used by the communication network 26.

In the example of embodiment in FIG. 1, the communication network 26 is a wireless communication network e.g. GPRS network (General Packet Radio Service) or UMTS (Universal Mobile Telecommunication System) network. The communication network 26 comprises a wireless link 52 between each parking meter and the computer server.

As a variant, the communication network is a wire network comprising a wire data link between each parking meter 12 and the computer server 25.

The capture means 27 are integrated in the parking meter 12 and arranged for example in the vicinity of the display screen 14. The capture means 27 comprise a camera capable of acquiring a video sequence and/or a microphone capable of recording an audio sequence and/or photographic apparatus.

The additional communication means 28 are short distance communication means, of the order of a few metres or a few tens of metres. The additional communication means 28 conform for example to the IEEE 802.15 standard, also known as the Bluetooth® standard. As a variant or in addition, the additional communication means 28 conform to the IEEE 802.11 standard, also known as the Wi-Fi standard, the parking meter 12 and the external electronic device forming an ad hoc network for example. As a variant or in addition, the additional communication means 28 are communication means via infrared waves.

In the example of embodiment in FIG. 1, the parking meter 12 does not comprise any wire link with an external device, the powering means 29 comprising a rechargeable battery, not illustrated, capable of being recharged via a solar panel 54 arranged on top of the parking meter. As a variant, the parking meter 12 is connected to an electric supply network via an electric supply wire link.

The software 38 for creating a personal message is capable of creating a minimessage of SMS type (Short Message Service) or MMS type (Multimedia Messaging Service), and the communication protocol then conforms to the SMPP protocol (Short Message Peer-to-Peer) or MMS protocol (Multimedia Messaging Service).

As a variant, or in addition, the creation software 38 is capable of creating an electronic mail known as an e-mail, the communication means 24 being capable of communicating with an internet server.

In addition, the creation software 38 is coupled with capture means 27 to insert an image or a video sequence or an audio sequence in the created message. The creation software 38 is capable for example of inserting an image in the minimessage of MMS type, or else a video or audio sequence in the e-mail.

In addition, the creation software 38 is coupled with the download software 46 to insert, in the created message, a file downloaded from the external electronic device via the additional communication means 28.

The discrimination software discriminating the end destination of the message to be transmitted 40 is able for example to add a header at the start of the message to be transmitted. The message header may for example comprise the telephone number or e-mail address of the addressee, the date and time of transmission and the format of the message e.g. text or binary. The computer server 25 comprises means for analysing the message header and means for routing the message towards its end destination in relation to the analysed header, for example in relation to the telephone number or e-mail address of the addressee.

In addition, the receiving software 45 is coupled with the download software 46 to download a file from the parking meter 12 to the external electronic device via the additional communication means 28, the said file being included in the electronic message received via the communication means 24.

The electronic device 47 is a mobile telephone for example.

The functioning of the parking meter 12 according to the invention will now be explained with the help of the flow chart in FIG. 2.

The parking meter 12 of the invention enables a user 30 to create and send a personal message e.g. of SMS or MMS type, or an e-mail to the electronic device 47 of the other user.

If the user 30 wishes to make use of this operating function of the parking meter, the user starts by inserting payment means in the payment device 20 at step 100, as prepayment for transmission of the personal message, the payment only being effectively cashed at a later time.

At step 110, the user 30 indicates the address of the addressee by entering for example the addressee's telephone number or e-mail address. The user 30 creates a personal electronic message using the entry keypad 16 and creation means 38, verifying the content of the message on the display screen 14 as and when the characters are entered.

As an additional possibility the user 30 inserts into the created message an image or video sequence or even an audio sequence acquired using the capture means 27.

As an additional possibility, the user 30 inserts in the created message a file downloaded from the external electronic device via the additional communication means 28.

After entering all the characters forming the personal message, the user validates the created message.

The discrimination means 40 then determine the end destination of the message to be transmitted in relation to the type of message, and add the corresponding header at the start of the message at step 120. If the message to be transmitted is the personal message previously created by the user, the end destination is the electronic device 47 of the other user to whom the message is addressed.

If the type of message to be transmitted is a parking message, since the parking meter 12 is also capable of transmitting parking messages to the management unit 50, the end destination of the message is the parking data management unit 50. The parking message may, for example, contain information on the operating status of the parking meter.

The user's personal message is then transmitted by the parking meter at step 130, the user having previously requested (step 110) the effective transmitting of this personal message via the triggering means 42.

After the computer server 25 has received acknowledgement of transmission of the message, the amount previously prepaid at step 100 is definitively cashed at step 140 and a receipt containing the text of the transmitted electronic message is printed out by the printing means 22.

In addition, the user 30 waits for a predetermined time after transmission of his/her personal message for the receipt of an electronic message in response to the previously transmitted message. Also additionally, the received electronic message comprises a file and the user 30 downloads this file from the parking meter 12 to the external electronic device via the additional communication means 28.

It will therefore be appreciated that the parking meter of the invention allows users to be offered an additional operating function, namely the transmission of an electronic message to another user, this message being of SMS or MMS type for example or even an e-mail. This operating function is of particular advantage for users who have forgotten or lost their mobile telephone, or who no longer have any battery charge or prepaid minutes on their mobile telephone and who urgently need to transmit an electronic message to a contact.

1. An on-street parking meter (12) capable of issuing a payment ticket, of the type comprising:
communication means (24) using a communication protocol with a computer server (25),
means (16) for entering alphanumeric characters,
means (14) for displaying the characters entered by a user (30),
means (36) for generating a parking message, and
means (44) for transmitting the message to the computer server,
characterized in that it further comprises:
means (38) for creating a personal message of the user (30) from the characters entered by the user;
means (40) for discriminating the end destination of the message to be transmitted, the end destination of the personal message of the user (30) being an electronic device of another user (48), and the end destination of the parking message being a parking data management unit (50); and
means (42) for triggering, on a request of the user, the transmission of said personal message to the computer server.

2. The parking meter (12) according to claim 1 further comprising capture means (27) of images and/or sound, the capture means (27) being connected to the creation means (38).

3. The parking meter (12) according to claim 1 comprising additional short distance communication means (28) and means (46) for downloading data from an external electronic device to the parking meter, the external electronic device being connected to the parking meter via the additional communication means (28).

4. The parking meter (12) according to claim 1, wherein the creation means (38) are capable of creating a short message of SMS or MMS type, the communication protocol conforming to the SMPP protocol or MMS protocol.

5. The parking meter (12) according to claim 1, wherein the creation means (38) are capable of creating an electronic mail, the communication means (24) being capable of communicating with an internet server.

6. The parking meter (12) according to claim 1, further comprising means (22) for printing a receipt comprising the text of the transmitted personal message.

7. The parking meter (12) according to claim 1, further comprising means (45) for receiving an electronic message in reply to a previously transmitted personal message.

8. An urban parking zone (10) comprising a plurality of on-street parking meters (12), characterized in that each parking meter (12) is according to claim 1.

9. A method for transmitting an electronic message from an on-street parking meter (12) capable of issuing a payment ticket and comprising communication means (24) with a computer server (25), means (16) for entering alphanumeric characters, means (14) for displaying the entered characters, means (36) for generating a parking message and means (44) for transmitting the message to the computer server,
the method being characterized in that it comprises:
the creation (110) of a personal electronic message from the characters entered by a user using the entry means (16);
discrimination (120) of the end destination of the message to be transmitted, the end destination of the personal message of the user (30) being the electronic device (47) of another user (48), and the end destination of the parking message being a parking data management unit (50); and
the transmission (130), on request of the user (30), of the said personal electronic message to the computer server (25).

10. The method according to claim 9 further comprising, after transmission (130) of the message, the printing (140) of a receipt containing the text of the transmitted electronic message.

11. The parking meter (12) according to claim 2 comprising additional short distance communication means (28) and means (46) for downloading data from an external electronic device to the parking meter, the external electronic device being connected to the parking meter via the additional communication means (28).

12. The parking meter (12) according to claim 2, wherein the creation means (38) are capable of creating a short message of SMS or MMS type, the communication protocol conforming to the SMPP protocol or MMS protocol.

13. The parking meter (12) according to claim 2, wherein the creation means (38) are capable of creating an electronic mail, the communication means (24) being capable of communicating with an internet server.

14. The parking meter (12) according to claim 2, further comprising means (22) for printing a receipt comprising the text of the transmitted personal message.

15. The parking meter (12) according to claim 2, further comprising means (45) for receiving an electronic message in reply to a previously transmitted personal message.
